(19) United States
(12) Patent Application Publication
(10) Pub. No.: US 2005/0172048 A1
(43) Pub. Date: Aug. 4, 2005

(54) Method for transmitting data via a data bus

(76) Inventors: Joerg Barthel, Hildesheim (DE); Dirk Behme, Hildesheim (DE)

Correspondence Address: KENYON & KENYON, ONE BROADWAY, NEW YORK, NY, 10004, US

(21) Appl. No.: 10/505,563

(22) PCT Filed: Jan. 20, 2003
(86) PCT No.: PCT/DE03/00138

(30) Foreign Application Priority Data
Feb. 26, 2002 (DE) 102 08 300.2

(51) Int. Cl. G06F 13/28

(52) U.S. Cl. 710/22

(57) ABSTRACT

A method for transferring data via a data bus, in particular via a PCI bus. The method provides for a second additional memory area in which all physical addresses of the memory pages are stored, to be set up in a main memory of an arithmetic-logic unit. During data transfer the requisite physical addresses are transferred autonomously.

### BACKGROUND INFORMATION

A standard personal computer (PC) is characterized by simple expandability, which may be accomplished for example through what are known as plug-in cards, which are inserted into expansion slots on the motherboard of a PC. Over time, a standard known as the PCI bus (PCI: peripheral component interconnect) has come to prevail for these expansions. This defines the mechanical and electrical properties of the data bus, as well as the configuration of the bus members.

A computer having a motherboard on which slots are provided for expansion cards is described in U.S. Pat. No. 5,765,008. These cards are connected to the motherboard via the PCI bus.

In one of the slots there is a “riser card,” which in turn provides a number of insertion options. In this way a plurality of plug-in cards may be inserted into the motherboard, so that numerous functions may be implemented.

Every PCI expansion card requires a PCI interface for linking to the PCI bus. This may be either a separate self-contained integrated circuit (PCI bridge), or a PCI interface implemented in a hardware description language (PCI core). The latter may be embedded into programmable logic modules, such as a FGPA (field programmable gate array) using additional freely definable logic.

Both variants of linkage to the PCI bus permit the development of expansion cards which link the PCI bus to a local self-definable logic unit, for example a local proprietary bus, through this interface module. When an FGPA-based approach is used, the local logic is absolutely freely configurable. In the case of commercial PCI bridges, the local interfaces are defined by the manufacturer of these circuits.

When booting the PC, after the self-configuration of the PCI bus (plug and play) is complete it is necessary to initialize the separate local logic on the expansion card. After initialization the card is able to begin its own operation, such as reading data into the computer. A driver is responsible for the communication (initialization, data transfer) between the expansion card and the operating system of the PC. This is a software program which is specially matched to the specific properties of the expansion card, and is thus able to initialize the card correctly. In addition, the driver maps the standard interface of the operating system which is available for communication with expansion cards on the expansion card. The driver forwards the data read and write requests from the operating system to the expansion card in a suitable form.

In addition to data transfer requests from the operating system, it is also possible for the expansion card to signal the PC that it needs data or wishes to deliver data. Signaling by the PC is accomplished by interrupts, which interrupt the normal sequential program execution of the PC. When an interrupt is initiated by an expansion card, the system jumps to a software routine specifically provided for this interruption by the driver, the interrupt service routine (ISR).

The ISR recognizes the nature of the interrupt request on the basis of the interrupt and attends to it, for example by reading data from the card and placing it in the main memory of the PC, thus making the data that has been read available to the application programs for further processing. The code in the ISR should be as short and compact as possible, in order to minimize the duration of the interruption and thus not to unnecessarily detract from the performance of the overall system.

In addition to the possibility of the processor itself performing the transfer of data between the main memory and an expansion card with the help of the driver, there is also direct memory access, or DMA transfer. In DMA transfer, the expansion card accesses the main memory of the PC directly. To this end, the main memory area from which the data for the card is to be read or to which the data is to be written is reported to the card directly through its starting address. The card thereupon gains control of the PCI bus (master) and transfers the data between the main memory area defined by the starting address and the PCI expansion card autonomously, without placing demands on the processor. After the data transfer is completed, the card releases an interrupt to inform the driver that the data has been transferred successfully.

Modern operating systems such as Windows NT/2000 and Linux are known as multitasking operating systems, which means that they provide processor time to a plurality of applications which are to be processed simultaneously, in the form of small time slices on the order of milliseconds. This time slice method gives the user of the PC the impression that all the active applications are working simultaneously. But since only a limited amount of main memory is available physically, independently of the number of applications running, modern processors employ the concept of virtual memory to circumvent this limitation and supply all applications with the memory they need.

The concept of virtual memory is based on simulating a very large (virtual) main memory (such as 2 GB) for all applications, even if significantly less physical memory is available (e.g., 128 MB). This is achieved by subdividing the memory into many small units, known as pages. The typical size of such a page is 4,096 bytes. If an application requests memory (for example for data or program code), it is provided with the needed memory in the form of a certain number of pages. The division of the memory into pages is hardware-supported by all modern processors. When an application accesses the memory, a Memory Management Unit (MMU) translates the virtual memory addresses into physical addresses. If the time slice of an application A elapses and the next application B also needs memory which was likewise just used by the first application A, the pages of the first application A are swapped out, for example to the hard disk. In that way the data or code from application A is not lost, but application B can nevertheless utilize the physical memory formerly used by application A.

If larger volumes of data, such as video data, are to be transferred between a PCI expansion card and the main memory of the PC, then an area of appropriate size must be reserved for this data in the main memory of the PC. If the reserved area is larger than one page of memory (e.g., 4,096 bytes), then it is necessarily made up of several contiguous pages of memory. These pages then have virtual addresses which logically follow each other. These virtual addresses are mapped by the MMU to the physically existing memory, it not being necessary for the virtual addresses to be mapped to physically sequential addresses by the translation.

The virtual pages corresponding to the physical pages may thus be widely scattered in the physical main memory of the PC. A data transfer via the PCI bus, on the other hand, works exclusively with the physical addresses of the memory. In order for a DMA transfer to read the data that is contiguous in virtual memory in the right order, or to write the data so that it is subsequently contiguous in virtual memory, it therefore must access the randomly distributed physical addresses of the individual pages. This means that each time only 4,096 bytes can be read or written in one transfer.

This problem is currently solved by having the driver determine the physical address for each virtual memory page and make it available to the expansion card. According to the conventional technology, two methods are known for this. According to the first method, the PCI interface on the expansion card contains a limited register memory for the page addresses of the main memory. According to the second method, the PCI interface on the expansion card contains enough register memory to hold all the page addresses for a complete data record.

As an illustrative example, it is assumed in the following case that a video image with CCIR resolution is to be transferred from the expansion card into the computer.

A CCIR image is made up of 720*576 pixels. In the YCbCr format each pixel requires 2 bytes, resulting in a data volume for a CCIR image of
720*576*2 bytes=829,440 bytes.

These 829,440 bytes occupy
829,440/4,096=202.5,
which rounds up to 203 pages in the main memory of the PC.

According to the first method, the PCI interface on the expansion card contains a limited (register) memory for the page addresses of the main memory. If the expansion card has for example eight registers for memory addresses (8*32 bits=32 bytes), before the beginning of a data transfer these eight registers must be initialized with valid addresses. Accordingly, a maximum of
8*4,096=32,786 bytes
may be transferred autonomously by the card per DMA into the main memory of the PC. After every DMA transfer an interrupt must be initiated, in order to announce the successful transfer and thereby request eight new memory addresses. If it is assumed for example that 25 CCIR images per second are to be transferred into the computer, this yields:
829,440*25 1/s=20,763,000 bytes/s
20,736,000 bytes/s/32,768 bytes=632.8 1/s

Consequently, 633 interrupts per second are used merely to transfer one second of image data.

According to the second method, the PCI interface on the expansion card contains enough (register) memory to hold all the page addresses for a complete CCIR image. For this application, this must therefore be at least 203 registers with 32 bits each (812 bytes).

Thus, for each image, only one interrupt is necessary, which confirms the successful data transfer and again requests 203 (new) addresses for the next image. So 25 images per second also result in 25 interrupts per second.

In the first method explained above, the performance of the system is significantly degraded due to the large number of interrupt requests.

Each of these requests forces the system to interrupt the current application, temporarily store the current contents of the CPU register, determine the source of the interrupt and execute the corresponding ISR. Then, after the old CPU register values are restored, the system returns to the previously interrupted application.

The advantage of this method is the small need for address registers (memory space equals chip area or FPGA resources) in the PCI interface on the expansion card because of the small number of page addresses to be stored.

Compared to the first method, the second method offers substantially increased performance, since the system has to process significantly fewer interrupt requests. This advantage is purchased at a significantly greater cost for hardware, however. The hardware cost in the example given (chip area or FPGA resources) is higher than that for the first method by a factor of 25.

### SUMMARY

A method according to the present invention is used to transfer data via a data bus, between a memory device which is subdivided into pages, the pages being accessible by means of physical addresses, and an electronic unit which is connected to the memory device through the data bus.

According to an example embodiment of the present invention, the memory device includes a first and a second memory area, the first memory area being provided for storing data and the second memory area containing the physical addresses of the pages of the first memory area or else of the entire memory device. The order of the physical addresses in the second memory area corresponds to the order of the virtual pages of the first memory area.

During data transfer, the requisite physical addresses are transferred autonomously from the second memory area to the electronic unit. Hence the physical unit is aware of the locations of the physical addresses. Autonomous transfer means, e.g., transferring without intervention by a system processor which is assigned to the memory device. The method thus now expands the approach in which the electronic unit is able to transfer data from the memory device autonomously and without intervention by the system processor, to the autonomous transfer of address data.

The example method according to the present invention thus combines the advantages of the two methods described earlier, namely low memory needs and low demand on the system, and avoids their disadvantages. Depending on the data transmission method used in the past, the method thus permits either a reduction in the number of interrupt requests and thus a significant enhancement of system performance, or else a greatly reduced need for hardware resources that are required to implement the PCI interface. At the same time, the manner of actual data transmission undergoes no change and is thus not affected. Only the way in which the page addresses are transferred is changed.

With the method according to the present invention it is thus no longer necessary to keep all of the addresses that are needed for complete transfer of the data in a memory on the electronic unit. The disadvantage of the second method, namely the high demand for memory within the interface of the electronic unit, is thus eliminated. On the other hand, although the electronic unit no longer stores all the physical addresses, an interrupt request is no longer sent to the system after a certain number of addresses have been processed, triggering an interruption of the current application as in the first method.

The method according to the present invention contains changes to both the hardware and software implementation of the PCI interface and driver. The hardware implementation is employable both with PCI bridges using standard IC technology and with PCI cores in a hardware description language. The software portion is independent of the operating system and may be utilized in any driver implementation.

Advantageously, at the beginning of data transfer a starting address of the second memory area is transmitted to the electronic unit. Thus the positions, i.e., the physical locations of the physical addresses of the pages of the memory device, are known to the electronic unit.

The method according to the present invention is suitable both for writing data from the electronic unit into the memory device and for reading data stored in the memory device.

The PCI bus, which is widely used, especially in PCs, may be used as the data bus.

In a refinement of the method according to the present invention, the memory device is a main memory located on a motherboard of an electronic arithmetic-logic unit (computer). A plug-in card or expansion card inserted into an expansion slot of the motherboard is provided as the electronic unit. In this case, the system processor is the CPU of the electronic arithmetic-logic unit.

Typically, the physical addresses are transferred to the electronic unit by DMA transfer.

The memory device according to the present invention is subdivided into pages, and includes a first memory area and a second memory area. The first memory area is provided for data; i.e., the data to be read is stored in this memory area, or data is written into this memory area. In the second memory area, the physical addresses of the pages of the first memory area are stored. These addresses allow access to the data stored in the first memory area and/or make it possible to write to the first memory area.

The memory device according to the present invention is preferably used as a main memory located on a motherboard of an electronic arithmetic-logic unit.

The motherboard of an electronic arithmetic-logic unit (computer) according to the present invention is characterized by the fact that a memory device according to the present invention is used as the main memory.

The electronic arithmetic-logic unit according to the present invention has a main memory. A memory device according to the present invention is provided as the main memory. The CPU of the arithmetic-logic unit functions as the system processor. The main memory is preferably located on a motherboard.

The system according to the present invention includes a memory device according to the present invention and an electronic unit according to the present invention. These are connected with each other via a bus, preferably the PCI bus, to transfer data and addresses.

The electronic device according to the present invention, in which an electronic computing device or CPU, a memory device and an electronic unit are integrated in one module, constitutes a compact system. Here all the components are integrated for example on one card or even in a single chip (SoC: system on a chip).

The computer program according to the present invention has program code for performing all steps of a procedure described above. The computer program is executed on a computer or an arithmetic-logic unit, in particular an electronic arithmetic-logic unit according to the present invention.

The computer program product according to the present invention includes exactly this program code, and is stored on a computer-readable data medium.

Additional advantages and embodiments of the present invention are described below and shown in the accompanying figures.

The features described above and those explained below are usable not only in the particular combinations indicated but also alone or in other combinations, without departing from the framework of the present invention.

### BRIEF DESCRIPTION OF THE DRAWINGS

The present invention is illustrated in the figures on the basis of exemplary embodiments, and will be explained in greater detail below with reference to the figures.

FIG. 1 shows a schematic representation of the basic structure of a PCI system.

FIG. 2 shows an expansion card having a PCI bus interface.

FIG. 3 illustrates the relationship between virtual and physical addresses.

FIG. 4 shows a schematic representation of a preferred embodiment of the electronic arithmetic-logic unit according to the present invention.

FIG. 5 illustrates the cooperation between a memory device according to the present invention and an expansion card.

FIG. 6 shows a preferred embodiment of the method according to the present invention in a flow chart.

### DETAILED DESCRIPTION OF EXAMPLE EMBODIMENTS

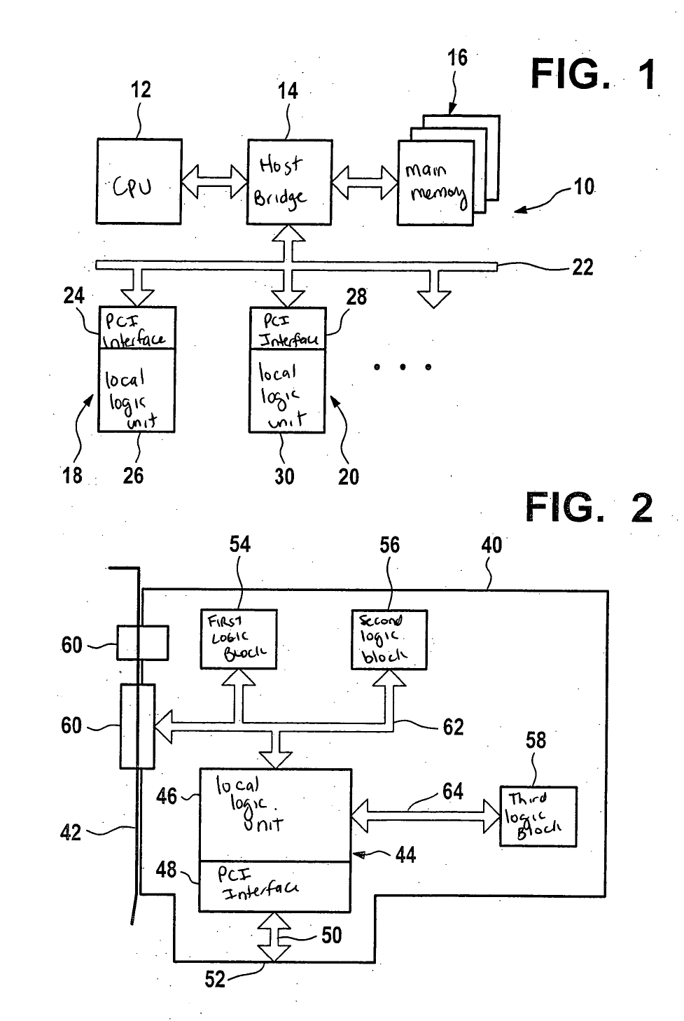

FIG. 1 illustrates the basic structure of a PCI system, designated as a whole with the reference number 10.

FIG. 1 shows a CPU 12, a host bridge 14, a main memory 16, a first PCI card 18, a second PCI card 20 and a PCI bus 22.

First PCI card 18 includes a first PCI interface 24 and a first local logic unit 26. Second PCI card 20 accordingly has a second PCI interface 28 and a second local logic unit 30.

PCI cards 18 and 20 are connected to PCI bus 22 via PCI interfaces 24 and 28. Thus local logic units 26 and 30 are also connected to PCI bus 22.

CPU 12 and main memory 16 are connected via host bridge 14.

FIG. 2 shows an expansion card or plug-in card 40 having a slot bracket 42.

On plug-in card 40 there is a PCI block 44, which in turn includes a local logic unit 46 and a PCI interface 48. As a double-ended arrow 50 makes clear, PCI interface 48 is connected to PCI bus 52 of the motherboard of the electronic arithmetic-logic unit.

Also included on plug-in card 40 are a first logic block 54, a second logic block 56 and a third logic block 58. Also shown are connector sockets 60, which ensure that plug-in card 40 is held firmly in place and include connections for data exchange.

Local logic unit 46 is connected to first and second logic blocks 54 and 56 through a local proprietary bus 62. Between local logic unit 46 and third logic block 58 there is also a direct connection 64.

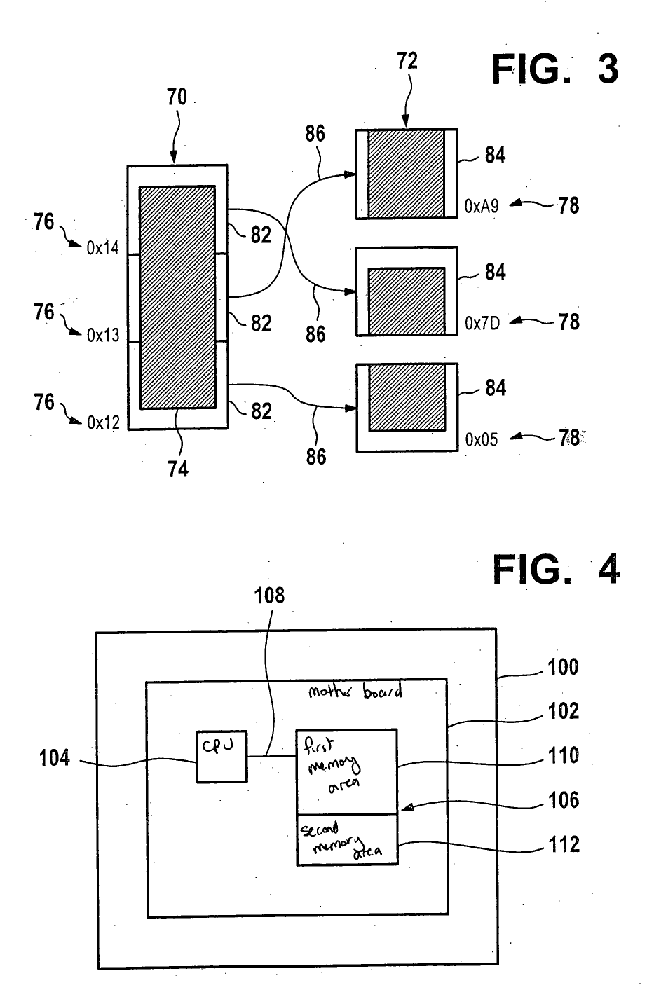

FIG. 3 illustrates the relationship between virtual and physical addresses.

Virtual organization 70 of the memory, designated below as virtual memory, and physical organization 72 of the memory, referred to below as physical memory are shown. Virtual memory 70 contains a data element 74. The specifications 0x14, 0x13 and 0x12 designated by reference number 76 are examples of virtual addresses. Examples of physical addresses 0xA9, 0x7D and 0x05 are designated with reference number 78.

Data element 74 in physical memory 70 includes three pages 82, which are identified with virtual addresses 76. These pages 82 have virtual addresses which follow each other logically. Reference number 84 designates three physical pages in physical memory 72. Arrows 86 illustrate the assignment of virtual memory 70 to physical memory 72. It can be seen that physical pages 84 which correspond to virtual pages 82 are widely scattered in the main memory. Virtual addresses 76 are mapped to the physically available memory 72 by the MMU.

Data transfer via the PCI bus works exclusively with the physical addresses 78 of physical memory 72. In order for a DMA transfer to read the data that is contiguous in virtual memory 70 in the right order, or to write the data so that it is subsequently contiguous in virtual memory 70, the randomly distributed physical addresses 78 must be accessed in conjunction with the transfer.

FIG. 4 shows a preferred embodiment of an electronic arithmetic-logic unit according to the present invention, designated as a whole with the reference number 100. Arithmetic-logic unit 100 is for example a computer or PC. The figure shows a motherboard 102, on which there are a CPU 104 and a memory device 106, the main memory 106 of electronic arithmetic-logic unit 100. CPU 104 and main memory 106 are connected with each other via a standard bus 108.

Main memory 106 includes a first memory area 110 and a second memory area 112. First memory area 110 is intended for data.

This means that the data that is to be accessed is stored in this area, and/or that data may be written to first memory area 110, for example by plug-in card 40. Second memory area 112 contains the physical addresses 78 of the pages of first memory area 110 or of the entire main memory 106.

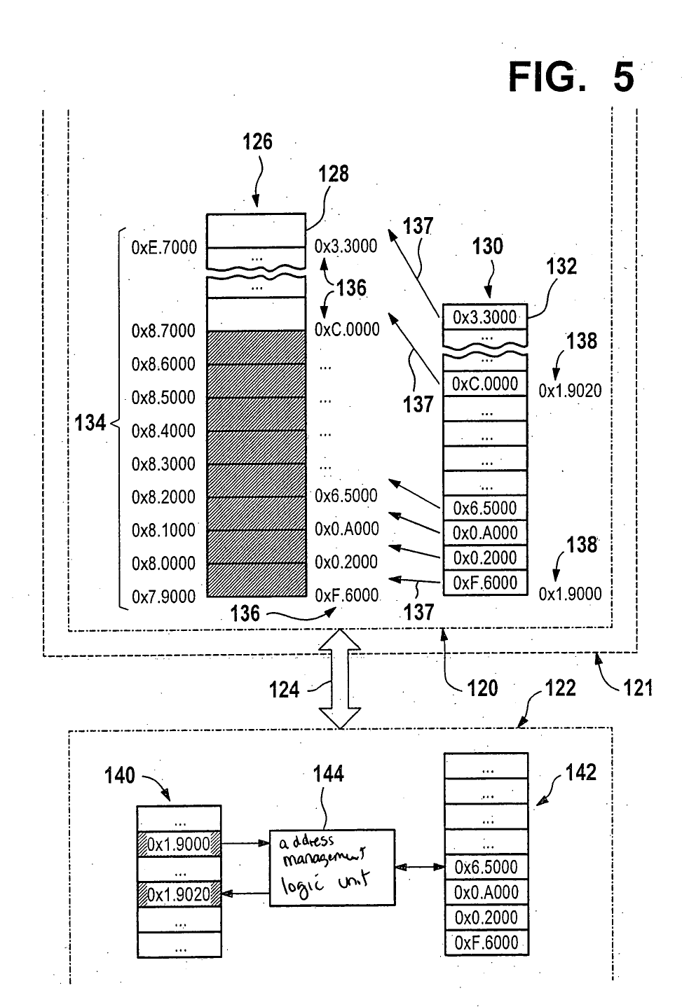

FIG. 5 illustrates the interaction between and electronic arithmetic-logic unit 121 and an expansion card 122 which are connected via a PCI bus 124. Electronic arithmetic-logic unit 121 contains a main memory 120.

Reference number 126 represents the first memory area of main memory 120, subdivided into pages 128. A page 128 typically contains 4,096 bytes.

Reference number 130 identifies the second memory area, namely the memory area for the address table, which is subdivided into address memory locations 132.

The data (0xE.7000 etc.) designated by 134 includes the virtual addresses, which follow each other logically. Data 136 (0x3.3000 etc.) includes the randomly distributed physical addresses of pages 128 of first memory area 126. Arrows 137 illustrate the assignment of the data of the address table contained in second memory area 130 to physical addresses 136 of pages 128 of first memory area 126. That is, second memory area 130 contains in an address table physical addresses 136 of first memory area 126.

The data 0x1.9020 and 0x1.9000 designated with 138 are the physical addresses of address memory locations 132 of second memory area 130, data 0x1.9000 representing the physical base address, i.e., the requisite starting address of the address table.

PCI expansion card 122 includes a register memory 140 which contains the local registers of expansion card 122. Requisite physical addresses 138 of second memory area 130 are stored in these registers. Data 0x1.9000 specifies the base address of the address table. Data 0x1.9020 is the exemplary base address of the next address block from the address table with an exemplary address block length of eight.

An address memory 142 contains local destination addresses, i.e., the content of second memory area 130 or physical addresses 136 of first memory area 126. The depth in the example is eight registers, which is filled per PCI master DMA by PCI expansion card 122. Address memory 142 thus contains addresses of eight pages 128. Between register memory 140 and address memory 142 there is an address management logic unit 144.

At the time of the initialization the driver creates a first memory area 126 of the size needed by the image data in the main memory of the PC. On the basis of this size it calculates the number of required memory pages 128 which occupy first memory area 126. Starting from there second memory area 130 is set up; physical addresses 136 of first memory area 126 are determined (in FIG. 5 0xF.6000, 0x0.2000 etc.) and are stored in second memory area 130. The physical base address, the starting address of the address table in second memory area 130 (in this case 0x1.9000), is reported by the driver to the expansion card. The latter stores the value in a local register, in this case in register memory 140.

At the start of the data transfer, the card begins for example to read eight base addresses 136 of memory pages 128 of the area reserved for the data transfer (0xF.6000, 0x0.2000 etc.) from main memory 120 of the PC per PCI master DMA, starting from base address 138 of the address table (0x1.9000), and to store them locally in 142. Next the data is also transferred per PCI master DMA to memory pages 128 thus referenced. As soon as 8*4,096 bytes of data have been transferred, in an additional PCI master DMA cycle the card obtains the new base addresses, i.e., physical addresses 136 for the next eight memory pages.

The internal logic of the PCI controller includes, in addition to the conventional logic, additional registers whose purpose is to manage the memory addresses for the address table. As with the management of the addresses for the data memory, here too the address is temporarily stored (0x1.9020) whose memory cell in turn contains the address (0x0.C000) that points to the next memory page to be used. Instead of triggering an interrupt request according to the known first method, the local address registers are now updated autonomously by the PCI controller.

Through the method according to the present invention, it is possible for only one interrupt to be triggered per data block, despite the smaller number of target address registers and the hardware resources thus saved. This one interrupt is also largely independent of the size of the data block. In the case of data blocks that are larger than 4 megabytes it may be necessary to use a plurality of address tables, since the address table itself here occupies more than one memory page, or else the updating of the address table is requested via more than one interrupt request per data block.

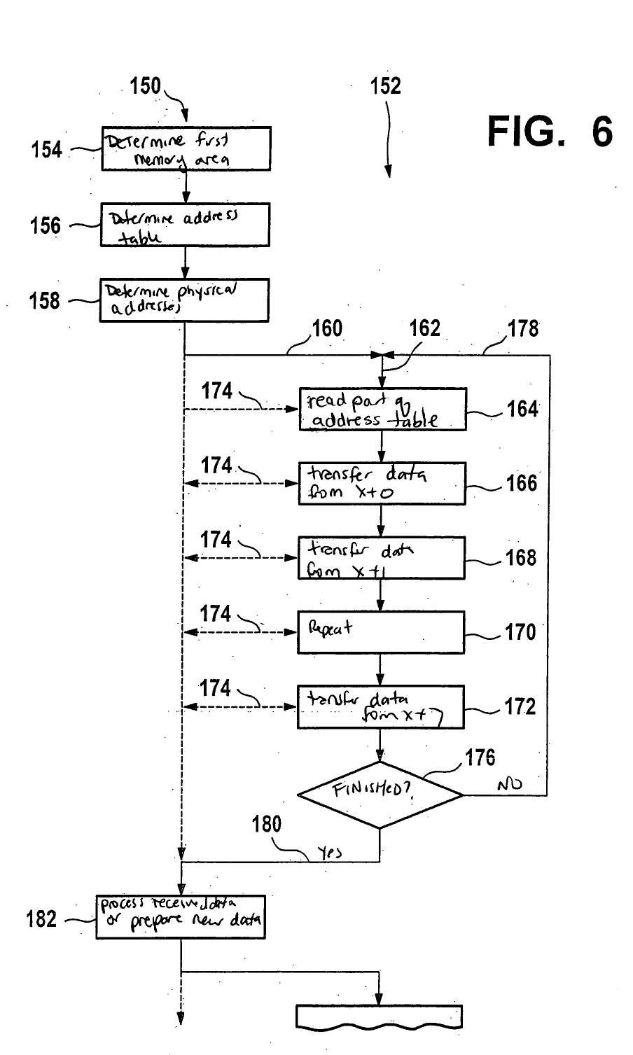

FIG. 6 shows a flow chart depicting a preferred embodiment of the method according to the present invention. Reference number 150 indicates the process steps that are executed by the driver. Reference number 152 indicates the process steps executed in the expansion card.

A first step 154 determines the first memory area, the data memory, and a step 156 determines the address table, i.e., the second memory area. Next, in a step 158 the physical addresses of the data memory are determined and stored in the address table.

As indicated by an arrow 160, the expansion card is initialized and the starting address of the address table is transferred.

At the start of data transfer, as shown by an arrow 162, the first part of the address table is first read from the PC main memory into the local memory of the expansion card in a step 164. The useful data from memory page x+0 is then transferred in a step 166. If the data block is not already completely transferred, transfer of the data from page x+1 then follows in a step 168. These procedures are repeated 170, until the transfer of the data from memory page x+7 is carried out in a step 172. The transfer takes place per PCI master DMA, as illustrated with dashed double-ended arrows 174.

In a step 176 a check is performed to determine whether the data block being transferred is finished, i.e., whether it has been completely transferred. If not, the sequence jumps back to process step 164 according to arrow 178. If the data block is completely transferred, an interrupt occurs, as illustrated by an arrow 180.

Then, in a step 182, received data is processed or new data is prepared for sending.

The PCI expansion card, as bus master, is capable of reading data per DMA from the main memory of the PC or writing to it, autonomously and without intervention by the system processor. However, to do so the expansion card needs the physical addresses of the main memory page from which it is to read or to which it is to write. In the two described methods from the related art, these addresses are actively written to the register memory of the PCI interface by the driver, and thus by the system processor or the CPU.

The method according to the present invention now expands the approach by which the expansion card is able to transfer data per DMA autonomously without intervention by the system processor, to the autonomous transfer of addresses. In addition to the first memory area in the main memory of the PC, which functions as data memory, a second, usually smaller memory area is also created. In this second memory area the driver now stores all the physical addresses of the memory pages that make up the first memory area.

When data transfer begins, now only the starting address for the second memory area is transmitted to the PCI interface on the expansion card. Hence, the expansion card is aware of the locations of the physical addresses of the main memory pages. During data transfer the expansion card is now able to get the destination or source addresses for the data in the first memory area from the second memory area autonomously as needed. Thus it is no longer necessary to keep all the requisite addresses for a complete data transfer in the memory on the expansion card. The disadvantage of the previously described second method, namely the high demand for memory within the PCI interface on the expansion card, is thus eliminated. On the other hand, although the expansion card no longer stores all the physical addresses, an interrupt request is no longer sent to the system for example after eight addresses have been processed, as in the first method, triggering an interruption of the current application.

The card itself reads the next page addresses per DMA from the second memory area into the internal address register. Hence only one interrupt is now triggered for each data block. The large number of interrupts according to the first method is thus avoided. Since it is now also no longer necessary to transmit the page addresses within the ISR, the time for processing the routine may also be reduced significantly.

If possible, the second memory area for the addresses should not exceed the size of one page, i.e., for example 4,096 bytes, since otherwise multiple page addresses would also be needed for the addresses that are kept in the second memory area. In general this is entirely adequate, however, as the following exemplary calculation shows.

In modern processors, addresses are 32 bits—4 bytes—in size. That means it is possible to store
4,096 bytes/4 bytes=1024
(page) addresses on one page of memory. These can be used to access 1024 pages. The memory area thus addressable consequently includes:
1,024*4,096 bytes=4,194,304 bytes=4 megabytes.

Independent of this, however, the presented invention is also usable for more than one such address table. Thus, even transfers of extensive volumes of data are possible. In this case a plurality of memory pages is defined as an address table and their starting address stored in the PCI interface.

1-15. (canceled)

16. A method for transferring data via a data bus between a memory device and an electronic unit via a data bus, the memory device including a first memory area subdivided into pages and a second memory area, the pages being accessed using physical addresses of the pages, the first memory area being intended for storing data and the second memory area containing the physical addresses of the pages of the first memory area, the method comprising:
transferring data between the memory device and the electronic unit; and
during the data transfer, autonomously transferring the physical addresses from the second memory area to the electronic unit.

17. The method as recited in claim 16, wherein at a beginning of the data transfer, a starting address of the second memory area is transmitted to the electronic unit.

18. The method as recited in claim 16, wherein during the data transfer, data from the electronic unit is written into the memory device.

19. The method as recited in claim 16, wherein during data transfer, data stored in the memory device is read by the electronic unit.

20. The method as recited in claim 16, wherein the data bus is a PCI bus.

21. The method as recited in claim 16, wherein the memory device is a main memory located on a motherboard of an electronic arithmetic-logic unit, and a plug-in card inserted into an expansion slot of the motherboard is provided as the electronic unit.

22. The method as recited in claim 16, wherein the physical addresses are transferred to the electronic unit by DMA transfer.

23. A memory device, comprising:
a first memory area subdivided into pages; and
a second memory area, the first memory area being intended for data, and physical addresses of the pages of the first memory area being stored in the second memory area.

24. A method of using a memory device, comprising:
providing a main memory located on a motherboard of an electronic arithmetic-logic unit, the main memory including a first memory area divided into pages; and
performing a data transfer using the main memory.

25. A motherboard of an electronic arithmetic-logic unit, comprising:
a processor; and
a main memory coupled to the processor via a bus, the main memory including a first memory area divided into pages and a second memory area storing physical addresses of the pages of the first memory area.

26. An electronic arithmetic-logic unit, comprising:
a motherboard; and
a main memory located on the motherboard, the main memory including:
a first memory area subdivided into pages, and
a second memory area, the first memory area being intended for data and physical addresses of the pages of the first memory area being stored in the second memory area.

27. A system, comprising:
an electronic unit; and
a memory device connected to the electronic unit via a data bus, the memory device including:
a first memory area subdivided into pages; and
a second memory area, the first memory area being intended for data and physical addresses of the pages of the first memory area being stored in the second memory area.

28. An electronic device, comprising:
an electronic arithmetic-logic unit;
a memory device, the memory device including a first memory area subdivided into pages, and a second memory area, the first memory area being intended for data and physical addresses of the pages of the first memory area being stored in the second memory area; and
an electronic unit;
wherein the electronic arithmetic-logic unit, the memory device, and the electronic unit are integrated in one component.

29. A computer program for execution by an electronic arithmetic-logic unit, the arithmetic-logic unit including a memory device having a first memory area divided into pages and a second memory area storing physical addresses of the pages of the first memory area, and an electronic unit, the program including program code which, when executed by the electronic arithmetic-logic unit, causes the electronic arithmetic-logic unit to perform the following:
transferring data between the memory device and the electronic unit; and
during the data transfer, autonomously transferring physical addresses from the second memory area to the electronic unit.

30. A memory device storing program code for execution by an electronic arithmetic-logic unit, having a memory device and an elecronic unit coupled via a data bus, the memory device having a first memory area divided into pages, and a second memory area storing physical addresses of the pages of the first memory area, the program code, when executed by the arithmetic logic unit, causes the arithmetic-logic unit to perform:
transferring data between the memory device and the electronic unit; and
during the data transfer, autonomously transferring physical addresses from the second memory area to the electronic unit.
